(19) United States
(12) Patent Application Publication
(10) Pub. No.: US 2026/0288577 A1
(43) Pub. Date: Sep. 24, 2026

(54) METHODS AND APPARATUSES FOR OPERATING MEMORY SYSTEMS

(71) Applicant: Yangtze Memory Technologies Co., Ltd., Wuhan (CN)

(72) Inventors: Tao XIONG, Wuhan (CN); Zhen CHEN, Wuhan (CN); Fa HUANG, Wuhan (CN); Jie JIA, Wuhan (CN); Lijian DENG, Wuhan (CN); Shijun SONG, Wuhan (CN)

(21) Appl. No.: 19/175,091

(22) Filed: Apr. 10, 2025

(30) Foreign Application Priority Data
Mar. 24, 2025 (CN) 202510348713.5

(51) Int. Cl. G06F 11/10

(52) U.S. Cl. CPC G06F 11/1016; G06F 11/1004; G06F 11/1068

(57) ABSTRACT

Methods, devices, apparatuses, and systems for operating memory systems are provided. In one aspect, a memory system includes a non-volatile memory device, a volatile memory device, and a controller coupled to the non-volatile memory device and the volatile memory device. The controller is configured to perform operations including, in response to determining a read error when reading a data unit from the volatile memory device, reading, from the non-volatile memory device and based on a data type of the data unit, information associated with the data unit, and recovering the data unit based on the information.

### CROSS-REFERENCE TO RELATED APPLICATIONS

This application claims priority to Chinese Patent Application No. 202510348713.5, filed on Mar. 24, 2025, which is hereby incorporated by reference in its entirety.

### TECHNICAL FIELD

The present disclosure generally relates to memory devices and memory systems, and in particular, to operating memory systems.

### BACKGROUND

Flash memory is a low-cost, high-density, nonvolatile solid-state storage medium that can be electrically erased and reprogrammed. Flash memory includes NOR flash memory and NAND flash memory. Various operations can be performed by a flash memory, for example, program (write) or read operations. Operations performed by a flash memory can affect temperature of the flash memory.

### SUMMARY

The present disclosure involves methods, apparatuses, and systems for operating a memory system, e.g., managing read errors when reading data from a volatile memory device (e.g., a DRAM memory device) of the memory system.

One aspect of the present disclosure provides a memory system. The memory system includes a non-volatile memory device, a volatile memory device, and a controller coupled to the non-volatile memory device and the volatile memory device. The controller is configured to perform operations including, in response to determining a read error when reading a data unit from the volatile memory device, reading, from the non-volatile memory device and based on a data type of the data unit, information associated with the data unit, and recovering the data unit based on the information.

In some implementations, the data unit includes more than one error bit.

In some implementations, the operations include, in response to determining that the data unit includes firmware code of the memory system, identifying an address in the image file of the firmware code that corresponds to the data unit, where the image file is stored in the non-volatile memory device, reading, based on the address, a portion of the image file at the address from the non-volatile memory device, and recovering the data unit based on the portion of the image file.

In some implementations, the operations include in response to determining that the data unit includes mapping information that maps a first logical address to a first physical address in the non-volatile memory device, reading meta data corresponding to data stored at the first physical address, and recovering the data unit based on the meta data.

In some implementations, recovering the data unit includes flipping two bits in the data unit, and determining whether the data unit that has the two bits flipped passes error correction code (ECC) verification.

In some implementations, flipping two bits in the data unit includes, flipping a first bit in the data unit, determining whether the data unit that has the first bit flipped includes a single error bit, and in response to determining that the data unit that has the first bit flipped includes a single error bit, flipping the single error bit.

In some implementations, the controller is configured to determine whether a data unit includes a single error bit by using a function based on Hamming codes.

In some implementations, flipping two bits in the data unit includes flipping all possible combinations of two bits in the data unit.

In some implementations, recovering the data unit based on the meta data includes in response to determining that the data unit that has the two bits flipped passes ECC verification, determining whether the data unit is successfully recovered by determining whether the first logical address is identical to a second logical address included in the meta data.

In some implementations, the operations further include, in response to determining that the data unit is successfully recovered, proceeding with a next operation, and in response to determining that the data unit is not successfully recovered, sending a response indicating an unrecoverable read error.

In some implementations, the data unit includes data bits and parity bits. The parity bits are generated based on Hamming codes.

In some implementations, the non-volatile memory device is a NAND memory device, and the volatile memory device is a DRAM memory device.

Another aspect of the present disclosure features a method of operating a memory system. The method includes, in response to determining a read error when reading a data unit from a volatile memory device of the memory system, reading, from a non-volatile memory device of the memory system and based on a data type of the data unit, information associated with the data unit, and recovering the data unit based on the information.

In some implementations, the data unit includes more than one error bit.

In some implementations, the method includes, in response to determining that the data unit includes firmware code of the memory system, identifying an address in the image file of the firmware code that corresponds to the data unit, where the image file is stored in the non-volatile memory device, reading, based on the address, a portion of the image file at the address from the non-volatile memory device, and recovering the data unit based on the portion of the image file.

In some implementations, the method includes, in response to determining that the data unit includes mapping information that maps a first logical address to a first physical address in the non-volatile memory device, reading meta data corresponding to data stored at the first physical address, and recovering the data unit based on the meta data.

In some implementations, recovering the data unit includes flipping two bits in the data unit, and determining whether the data unit that has the two bits flipped passes error correction code (ECC) verification.

In some implementations, flipping two bits in the data unit includes flipping a first bit in the data unit, determining whether the data unit that has the first bit flipped includes a single error bit, and in response to determining that the data unit that has the first bit flipped includes a single error bit, flipping the single error bit.

In some implementations, the method includes determining whether a data unit includes a single error bit by using a function based on Hamming codes.

A further aspect of the present disclosure features a controller including one or more processors configured to perform operations including, in response to determining a read error when reading a data unit from a volatile memory device coupled to the controller, reading, from a non-volatile memory device coupled to the controller and based on a data type of the data unit, information associated with the data unit, and recovering the data unit based on the information.

An additional aspect of the present disclosure features a non-transitory, computer-readable medium. The non-transitory, computer-readable medium stores one or more instructions executable by a memory system to perform operations including, in response to determining a read error when reading a data unit from a volatile memory device coupled to the controller, reading, from a non-volatile memory device coupled to the controller and based on a data type of the data unit, information associated with the data unit, and recovering the data unit based on the information.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates a block diagram of an example system having an example memory system.

FIGS. 2A-2B illustrate example storage products.

FIG. 3 illustrates an example of a schematic diagram of an example memory device.

FIG. 4 illustrates some example peripheral circuits.

FIG. 5 illustrates an example process of managing a read error when reading data from a volatile memory device of a memory system.

FIG. 6 illustrates an example data unit in a volatile memory device of a memory system.

FIG. 7 illustrates an example process of performing brutal-force decoding on a data unit having two error bits.

FIG. 8 illustrates a flow chart of an example method of operating a memory system.

Like reference numbers and designations in the various drawings indicate like elements.

### DETAILED DESCRIPTION

As performance requirements for memory systems (e.g., solid-state drives (SSDs)) continue to escalate, reliability requirements for memory systems, especially enterprise SSDs, are elevated. Reliability metrics for SSDs include mean time between failures (MTBF), defective parts per million (DPPM), and annual failure rate (AFR). A memory system can include one or more non-volatile memory devices (e.g., NAND memory devices) and a volatile memory device (e.g., a DRAM memory device). Read errors with respect to the volatile memory device can impact the overall reliability of the memory system.

In some cases, data can be stored in the volatile memory device in the form of data units, where each data unit has data bits and parity bits generated based on error correction codes (e.g., Hamming codes). If a data unit has a single error bit, the data unit can be recovered based on the error correction codes. In some cases, if a data unit has two or more error bits, the error correction codes may not be able to recover the data unit, and therefore the read error may be an unrecoverable read error.

The present disclosure provides techniques to manage read errors in the volatile memory device of the memory system, so that a data unit having more than one error bit may be recovered. In some implementations, a controller coupled to the volatile memory device and the non-volatile memory device can determine a data type of the data unit having more than one error bit, read associated information from the non-volatile memory device, and recover the data unit based on the information. For example, if the data unit includes firmware code of the memory system, the controller can read a corresponding portion of an image file of the firmware code from the non-volatile memory device. For another example, if the data unit includes mapping information that maps a first logical address to a first physical address, the controller can perform brutal-force decoding on the data unit to identify possible decoding solutions. The controller can further verify each possible decoding solution by reading meta data corresponding to the data stored at the first physical address from the non-volatile memory device, and comparing the logical address included in the meta data with the first logical address.

The described techniques can achieve one or more technical effects (e.g., technical advantages and/or benefits). For example, by recovering data units having more than one error bit in the volatile memory device, the memory system is less likely to encounter unrecoverable read errors. As such, the reliability performance of the memory system can be improved. For another example, the described techniques can be achieved by updating firmware algorithms of the memory system, without requiring hardware changes, which is a cost-effective way to improve the reliability performance of the memory system. In some implementations, additional or different technical effects can be achieved.

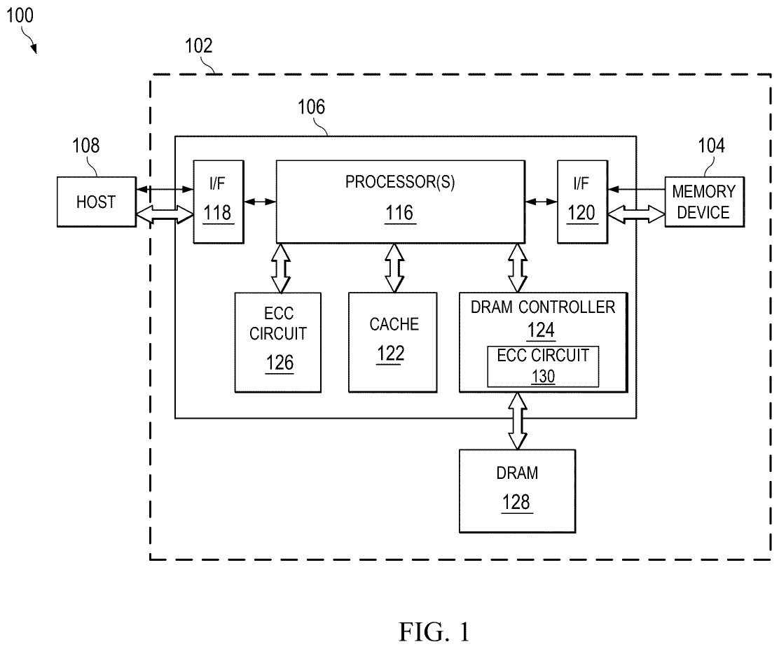

FIG. 1 illustrates a block diagram of an example system 100 having an example memory system 102. As shown in FIG. 1, the system 100 can include a host 108 and a memory system 102 having one or more memory devices 104 and a controller 106. The memory system 102 further includes a volatile memory device, such as a dynamic random-access memory (DRAM) 128 coupled to the controller 106. In some implementations, the memory system 102 can be a solid-state drive (SSD), for example, an enterprise SSD. The host 108 can be a processor of an electronic device, such as a central processing unit (CPU), or a system-on-chip (SoC), such as an application processor (AP). Host 108 can be configured to send or receive data to or from memory devices 104. The memory device 104 can be a non-volatile memory device, such as a NAND flash memory or any memory device disclosed in the present disclosure.

The controller 106 is coupled to the memory device 104, the DRAM 128, and the host 108 and is configured to control the memory device 104 and the DRAM 128. The controller 106 can manage the data stored in the memory device 104 and the DRAM 128, and communicate with the host 108. In some implementations, the controller 106 is designed for operating in a low duty-cycle environment like secure digital (SD) cards, compact Flash (CF) cards, universal serial bus (USB) Flash drives, or other media for use in electronic devices, such as personal computers, digital cameras, mobile phones, etc. In some implementations, the controller 106 is designed for operating in a high duty-cycle environment solid state drives (SSDs) or embedded multi-media-cards (eMMCs) used as data storage for mobile devices, such as smartphones, tablets, laptop computers, etc., and enterprise storage arrays. The controller 106 can be configured to control operations of the memory device 104 and the DRAM 128, such as read, erase, and program operations. The controller 106 can also be configured to manage various functions with respect to the data stored or to be stored in the memory device 104 including, but not limited to bad-block management, garbage collection, logical-to-physical address conversion, wear leveling, etc. In some implementations, the controller 106 is further configured to process error correction codes (ECCs) with respect to the data read from or written to memory device 104. Any other suitable functions may be performed by the controller 106 as well, for example, formatting the memory device 104.

In some implementations, the memory system 102 does not include the controller 106, and host 108 is coupled to the memory device 104 directly. For example, the controller 106 may be located in the host 108. Alternatively, the host 108 may not include the controller 106 but may be configured to perform functions similar to what controller 106 does as described above.

The controller 106 includes one or more processors 116, a host interface 118, a memory interface 120, a cache 122, a DRAM controller 124, and an ECC circuit 126.

The controller 106 can communicate with an external device (e.g., host 108) according to a particular communication protocol. As shown in FIG. 1, the processor 116 is coupled to the host 108 through the host interface 118. The host interface 118 allows the controller 106 to communicate with the external device through at least one of various interface protocols, such as a USB protocol, an MMC protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a Firewire protocol, etc.

The processor 116 may be coupled to a cache 122, a DRAM controller 124, and an ECC circuit 126. The cache 122 may be configured to store temporary information, e.g., data received from the host 108 before writing the data to the memory device 104, or data read from the memory device 104 before sending the data to the host 108.

The ECC circuit 126 is configured to process error correction codes with respect to the data read from or written to the memory device 104. Example error correction codes can include, but are not limited to, Hamming codes, Reed-Solomon codes, Bose-Chaudhuri-Hocquenghem (BCH) codes, low-density parity check (LDPC) codes, etc. In some implementations, the ECC circuit 126 includes an LDPC encoder configured to generate parity data based on LDPC codes for host data received from the host 108, so that both the host data and the parity data can be sent to the memory device 104 for storage. The ECC circuit 126 can further include an LDPC decoder configured to decode data comprising the host data and the parity data. The ECC circuit 126 can determine whether data stored in the block is read successfully (e.g., with no errors). If the data stored in the block is read successfully, the memory interface 120 can forward the data to the host interface 118, so that the host interface 118 can return the data to the host 108. However, if the data stored in the memory block is not read successfully, the memory interface 120 can generate data describing a read error on the memory block.

The DRAM controller 124 may be configured to access information stored in the DRAM 128. The DRAM 128 can be configured to store information such as firmware code of the memory system, firmware data and variables (e.g., generated when the memory system 102 is in operation), logical to physical (L2P) mapping table that maps logical addresses to physical addresses. In some implementations, the DRAM 128 can temporarily store host data received from the host 108, and/or data received from the memory device 104 during garbage collection.

In some implementations, the L2P mapping table can be the form of a one-dimensional array that stores physical addresses (e.g., physical allocation address (PAA), where each PAA corresponds to 4 kB of data), where the sequence of each physical address in the array represents the respective logical address (e.g., logical allocation address (LAA), also referred to as logical block number (LBN), where each LAA corresponds to 4 kB of data). As an example, each physical address in the array can take up 32 bits, 33 bits, or 34 bits. In some implementations, the logical address included in a read command or a write command from the host 108 can be a logical block address (LBA) that corresponds to 512 bytes of data. The host interface 118 can convert LBAs into LAAs, so that the controller 106 can manage data stored in the memory system based on LAAs and PAAs.

In some implementations, the DRAM controller 124 can include an ECC circuit 130 configured to process error correction codes with respect to the data read from or written to the DRAM 128. Example error correction codes can include, but are not limited to, Hamming codes, Reed-Solomon codes, etc. In some implementations, the ECC circuit 130 includes an encoder configured to generate parity data based on Hamming codes for data to be stored in the DRAM 128. The ECC circuit 130 can further include a decoder configured to decode data using the parity data based on Hamming codes. The ECC circuit 130 can determine whether data is successfully read (e.g., with no errors) from the DRAM 128. Further, in some cases, the ECC circuit 130 can recover compromised data using the corresponding parity data. If the data stored in the DRAM 128 has an error that cannot be successfully recovered, the host interface 118 can send a response to the host 108 indicating an unrecoverable read error (e.g., an uncorrectable error correction code (UECC) response).

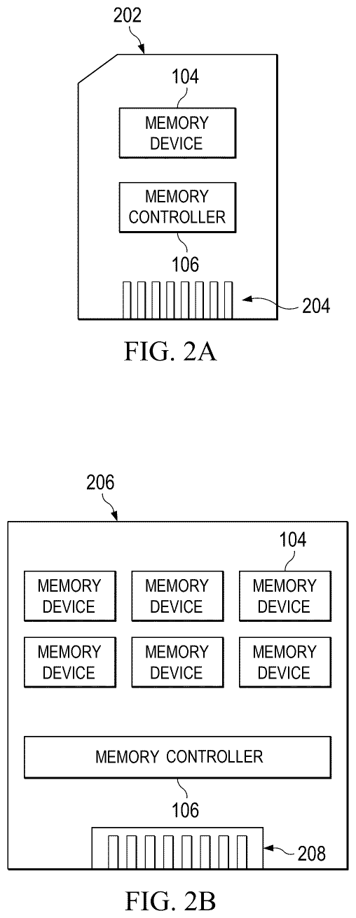

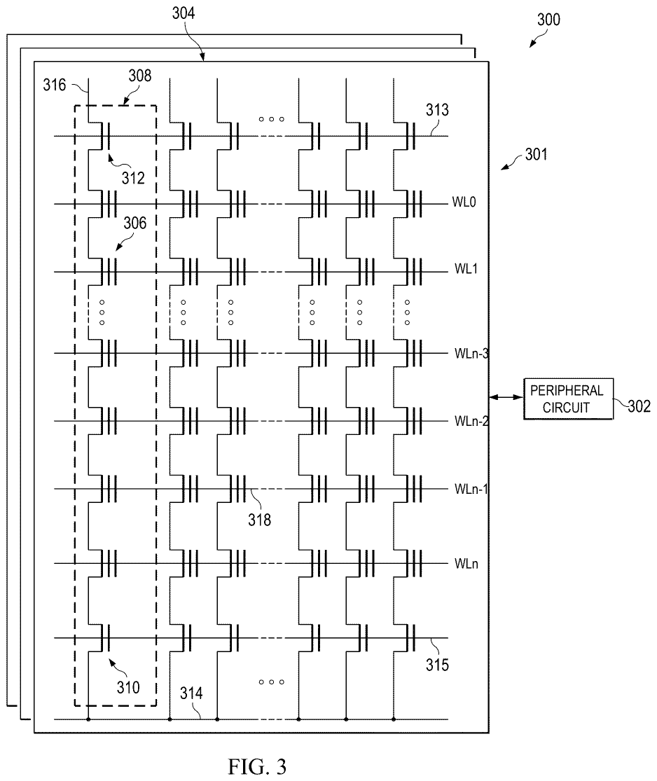

The memory system 102 having the controller 106 and one or more memory devices 104 can be integrated into various types of storage devices, for example, be included in the same package, such as a universal Flash storage (UFS) package or an eMMC package. That is, memory system 102 can be implemented and packaged into different types of end electronic products. In one example as shown in FIG. 2A, controller 106 and a single memory device 104 may be integrated into a memory card 202. Memory card 202 can include a PC card (PCMCIA, personal computer memory card international association), a CF card, a smart media (SM) card, a memory stick, a multimedia card (MMC, RS-MMC, MMCmicro), an SD card (SD, miniSD, microSD, SDHC), a UFS, etc. Memory card 202 can further include a memory card connector 204 coupling memory card 202 with a host (e.g., host 108 in FIG. 1). In another example as shown in FIG. 2B, controller 106 and multiple memory devices 104 may be integrated into an SSD 206. SSD 206 can further include an SSD connector 208 coupling SSD 206 with a host (e.g., host 108 in FIG. 1). In some implementations, the storage capacity and/or the operation speed of SSD 206 is greater than those of memory card 202.

FIG. 3 illustrates an example of a schematic diagram of a memory device 300 including peripheral circuits, according to some aspects of the present disclosure. The memory device 300 can be an example of the memory device 104 of FIGS. 1-2B. The memory device 300 can include a memory cell array 301 and peripheral circuits 302 coupled to the memory cell array 301. The memory cell array 301 can be a NAND Flash memory cell array in which memory cells 306 are provided in the form of an array of memory strings 308 each extending vertically above a substrate (not shown in FIG. 3). In some implementations, each memory string 308 includes a plurality of memory cells 306 coupled in series and stacked vertically. Each memory cell 306 can hold a continuous, analog value, such as an electrical voltage or charge that depends on the number of electrons trapped within a storage layer of the memory cell 306. The logic state (i.e., data) of each memory cell 306 in a memory block 304 can be determined based on the threshold voltage Vth of the memory cell 306. Each memory cell 306 can be a floating gate type memory cell including a floating-gate transistor, or a charge trap type memory cell including a charge-trap transistor.

In some implementations, each memory cell 306 is a single-level cell (SLC) with two possible memory states that can store one bit of data. For example, the first memory state “0” can correspond to a first range of voltages, and the second memory state “1” can correspond to a second range of voltages. In some implementations, each memory cell 306 is a multi-level cell (MLC) that is capable of storing more than one bit of data in more than two memory states. For example, the MLC can store two bits per cell, three bits per cell (also known as triple-level cell (TLC)), or four bits per cell (also known as a quad-level cell (QLC)). Each MLC can be programmed to support a range of possible nominal storage values. In one example, if each MLC stores two bits of data, then the MLC can be programmed to one of three possible programming levels from an erased state by writing one of three possible nominal storage values to the cell. A fourth nominal storage value can be used for the erased state.

As shown in FIG. 3, each memory string 308 can include a source select gate (SSG) 310 at its source end and a drain select gate (DSG) 312 at its drain end. The SSG 310 and the DSG 312 can be configured to activate selected memory strings 308 (columns of the array) during read and program operations. In some implementations, the sources of memory strings 308 in the same memory block 304 are coupled through a same source line (SL) 314, e.g., a common SL. In other words, memory strings 308 in the same memory block 304 have an array common source (ACS), according to some implementations. The DSG 312 of each memory string 308 is coupled to a respective bit line 316 from which data can be read or written via an output bus (not shown), according to some implementations. In some implementations, each memory string 308 is configured to be selected or deselected by applying a select voltage (e.g., above the threshold voltage of the transistor having the DSG 312) or a deselect voltage (e.g., 0 V) to the respective DSG 312 through one or more DSG lines 313, and/or by applying a select voltage (e.g., above the threshold voltage of the transistor having the SSG 310) or a deselect voltage (e.g., 0 V) to the respective SSG 310 through one or more SSG lines 315.

As shown in FIG. 3, memory strings 308 can be organized into multiple memory blocks 304, each of which can have a common SL 314 coupled to the ACS. In some implementations, each memory block 304 can serve as a basic data unit for erase operations, such that memory cells 306 on the same memory block 304 are erased at the same time. To erase memory cells 306 in a selected memory block 304, the SL 314 coupled to the selected memory block 304 and unselected memory blocks in the same plane can be biased with an erase voltage. For example, the erase voltage can be a high positive voltage (e.g., 20 V or more). In some implementations, an erase operation can be performed at a half-block level, a quarter-block level, or a level having any suitable number of memory blocks or fractions of a memory block.

The memory cells 306 of adjacent memory strings 308 can be coupled through word lines 318. The word line 318 can select which row of memory cells 306 is affected by read and program operations. Each word line 318 can include a gate line coupled to a plurality of control gates (gate electrodes) of a plurality of memory cells 306. Example word lines shown in FIG. 3 are between one or more DSG lines 313 and one or more SSG lines 315.

In some implementations, the memory cells 306 of adjacent memory strings 308 can be coupled through word lines 318. The word line 318 can select which row of memory cells 306 is affected by read and program operations. In some implementations where memory cells 306 are SLCs, one row of memory cells 306 can store one logical page of data, and therefore corresponds to one logical page. In some implementations where memory cells 306 are MLCs, one row of memory cells 306 can store two logical pages of data, and therefore corresponds to two logical pages. In some implementations where memory cells 306 are TLCs, one row of memory cells 306 can store three logical pages of data, and therefore corresponds to three logical pages. In some implementations where memory cells 306 are QLCs, one row of memory cells 306 can store four logical pages of data, and therefore corresponds to four logical pages.

Each word line 318 can include a gate line coupled to a plurality of control gates (gate electrodes) of a plurality of memory cells 306. Example word lines shown in FIG. 3 include WL0, WL1, . . . , WLn−2, WLn−1, and WLn that are between DSG line 313 and SSG line 315. In some implementations, the word lines can further include dummy word lines coupled to dummy memory cells.

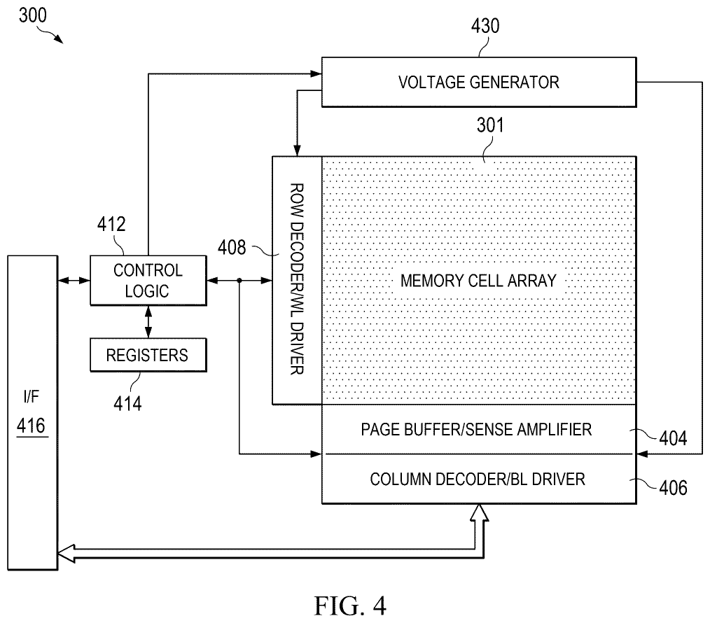

FIG. 4 illustrates some example peripheral circuits 302, according to some aspects of the present disclosure. The peripheral circuits 302 can be coupled to the memory cell array 301 through bit lines 316, word lines 318, SLs 314, SSG lines 315, and DSG lines 313. The peripheral circuits 302 can include any suitable analog, digital, and mixed-signal circuits for facilitating the operations of the memory cell array 301 by applying and sensing voltage signals and/or current signals to and from each target memory cell 306 through bit lines 316, word lines 318, SLs 314, SSG lines 315, and DSG lines 313. The peripheral circuits 302 can include various types of peripheral circuits formed using metal-oxide-semiconductor (MOS) technologies. The example peripheral circuits 302 include a page buffer/sense amplifier 404, a column decoder/bit line driver 406, a row decoder/word line driver 408, a voltage generator 410, control logic 412, registers 414, an interface 416, and a data bus. In some examples, additional peripheral circuits not shown in FIG. 4 may be included as well.

The page buffer/sense amplifier 404 can be configured to read and program (write) data from and to memory cell array 301 according to the control signals from control logic 412. In an example, the page buffer/sense amplifier 404 may store one page of program data (write data) to be programmed into the memory cell array 301. In another example, the page buffer/sense amplifier 404 may perform program verify operations to ensure that the data have been properly programmed into memory cells 306 coupled to selected word lines 318. In still another example, the page buffer/sense amplifier 404 may also sense the low power signals from the bit line 316 that represents a data bit stored in memory cell 306, and amplify the small voltage swing to recognizable logic levels in a read operation. The column decoder/bit line driver 406 can be configured to be controlled by the control logic 412 and select one or more memory strings 308 by applying bit line voltages generated from the voltage generator 410.

The row decoder/word line driver 408 can be configured to be controlled by the control logic 412 and select/deselect memory blocks 304 of the memory cell array 301 and select/deselect word lines 318 of the memory block 304. The row decoder/word line driver 408 can be further configured to drive word lines 318 using word line voltages generated from the voltage generator 410. In some implementations, the row decoder/word line driver 408 can also select/deselect and drive SSG lines 315 and DSG lines 313. As described below in detail, the row decoder/word line driver 408 is configured to apply a program voltage to selected word line 318 in a program operation on memory cell 306 coupled to selected word line 318.

The voltage generator 410 can be configured to be controlled by the control logic 412 and generate the word line voltages (e.g., read reference voltage, program voltage, pass voltage, local voltage, verify voltage, etc.), bit line voltages, and source line voltages to be supplied to the memory cell array 301.

The control logic 412 can be coupled to each peripheral circuit described above and configured to control operations of each peripheral circuit. The registers 414 can be coupled to the control logic 412 and include status registers, command registers, and address registers for storing status information, command operation codes (OP codes), and command addresses for controlling the operations of each peripheral circuit.

The interface 416 can be coupled to the control logic 412 and act as a control buffer to buffer and relay control commands received from a host (not shown) to the control logic 412 and status information received from the control logic 412 to the host. The interface 416 can also be coupled to the column decoder/bit line driver 406 via a data bus, and act as a data input/output (I/O) interface and a data buffer to buffer and relay data to and from the memory cell array 301.

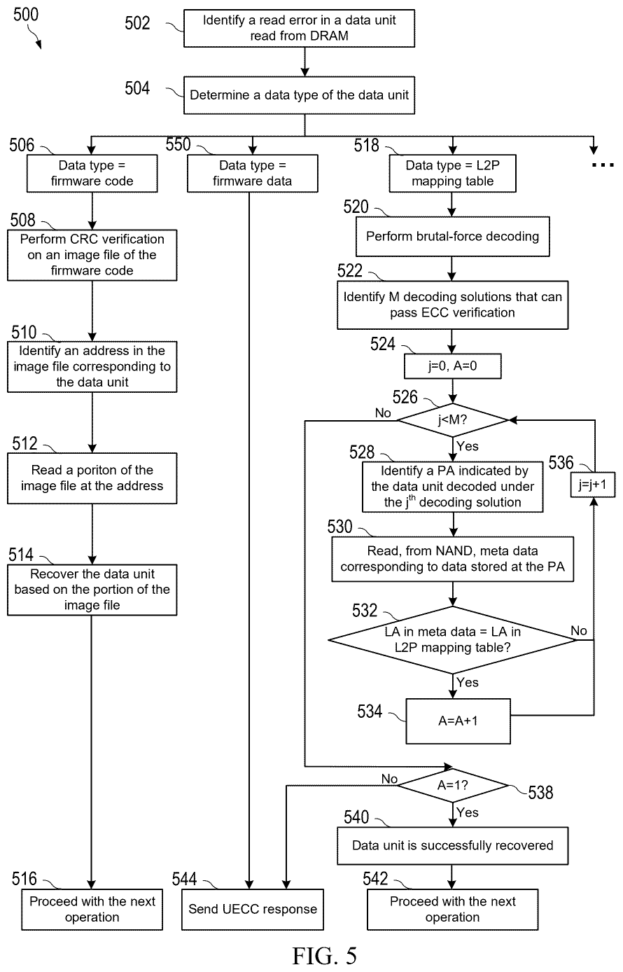

FIG. 5 illustrates an example process 500 of managing a read error when reading data from a volatile memory device, e.g., a DRAM (e.g., DRAM 128 of FIG. 1), of a memory system (e.g., memory system 102 of FIG. 1).

The operations shown in the process 500 may not be exhaustive and other operations can be performed as well before, after, or in between any of the illustrated operations. Further, some of the operations may be performed simultaneously, or in a different order than shown in FIG. 5. In some implementations, some of the operations may be performed by or one or more components of a device or a system, such as a controller (e.g., controller 106 of FIG. 1) of a memory system.

At 502, the controller identifies a read error in a data unit 600 read from the DRAM. For example, an ECC circuit (e.g., ECC circuit 130 of FIG. 1) of a DRAM controller (e.g., DRAM controller 124 of FIG. 1) of the controller can determine a read error when reading data from the DRAM, and identify the data unit that has more than one error bit (e.g., a bit that has been erroneously flipped from 1 to 0, or from 0 to 1).

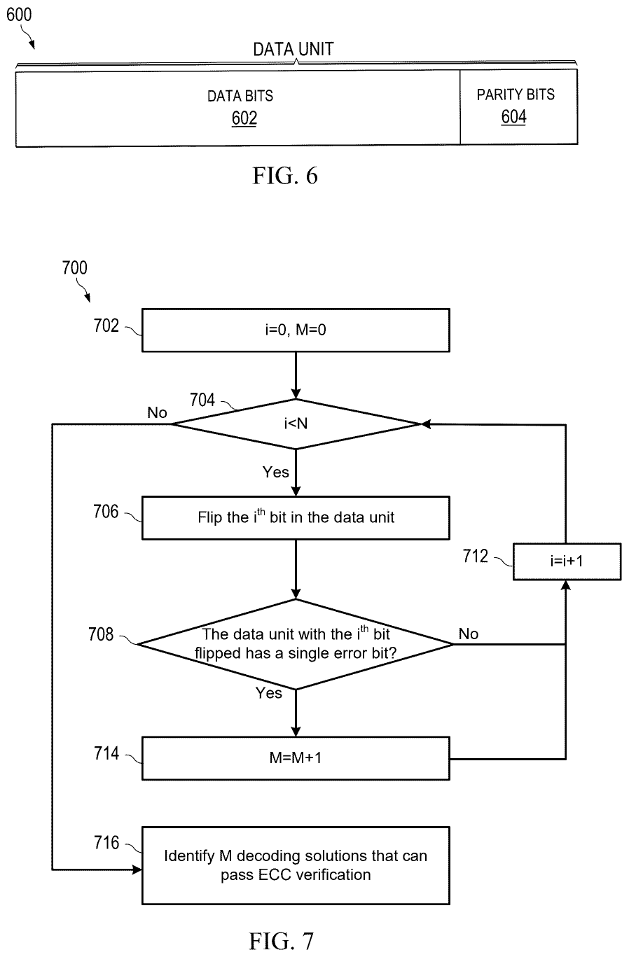

With reference to FIG. 6, data in the DRAM can be stored as data units. A data unit 600 can include data bits 602, and parity bits 604 generated based on ECC codes (e.g., Hamming codes) corresponding to the data bits 602. As an example, a data unit 600 having parity bits 604 that are generated based on Hamming codes can include 64 data bits and 8 parity bits. It should be noted that the data unit 600 can include any suitable number of data bits 602 and parity bits 604, and the parity bits 604 can be generated based on Reed-Solomon codes or other suitable ECC codes.

In some cases, the Hamming codes can be configured for single error correction and double error detection (SECDED). When the data unit 600 has a single error bit, the ECC circuit of the DRAM controller can identify the error bit and correct the error bit based on the Hamming codes. For example, the position of the error bit can be determined by recomputing parity bits using the data bits 602 having the error bit, and comparing the recomputed parity bits with the parity bits in the data unit 600. By identifying the position of the error bit, the error bit can be flipped back to the correct bit. When the data unit 600 has two error bits, the ECC circuit of the DRAM controller may detect the presence of two error bits based on the Hamming codes, but may not be able to correct the two error bits directly using the parity bits 604.

At 504, the controller determines a data type of the data unit 600 that has more than one error bit. For example, the data type of the data unit 600 can be firmware code, firmware data and variables, host data received from the host, data received from the non-volatile memory device during garbage collection, or mapping information (e.g., L2P mapping table). Based on the data type of the data unit 600, the controller can recover the data unit 600 by reading associated information from the non-volatile memory device (e.g., the NAND memory device 104 of FIG. 1) of the memory system.

At 506, in response to determining that the data type of the data unit is firmware code of the memory system, the process 500 proceeds to 508.

At 508, the controller performs a cyclic redundancy check (CRC) to verify an image file of the firmware code. The image file of the firmware code can be stored in the non-volatile memory device as a backup file. The CRC can verify that the image file of the firmware code is not corrupted.

At 510, the controller identifies an address (e.g., an offset) in the image file of the firmware code, where the address corresponds to the data unit 600 having error bits.

At 512, the controller reads a portion of the image file of the firmware code at the identified address from the non-volatile memory device. The portion of the image file can include the correct data that corresponds to the data unit 600 having error bits.

At 514, the controller recovers the data unit 600 based on the portion of the image file that is read from the non-volatile memory device. For example, the controller can write the portion of the image file in the DRAM in replacement of the data unit having error bits. For another example, the controller can write the portion of the image file at a new address in the DRAM.

In some implementations, after verifying the image file based on CRC, the controller may read the entire image file from the non-volatile memory device, and replace the firmware code in the DRAM with the image file.

At 516, the controller proceeds with the next operation, without sending a response to the host indicating an unrecoverable read error (e.g., a UECC response).

At 518, in response to determining that the data type of the data unit 600 is mapping information (e.g., L2P mapping table), the process 500 proceeds to 520. Specifically, the data unit 600 having error bits can include a physical address (PA) in the L2P mapping table.

At 520, the controller performs brutal-force decoding on the data unit 600 having more than one error bit. In some implementations, brutal-force decoding includes flipping two bits in the data unit 600, and determining whether the data unit 600 that has the two bits flipped can pass ECC verification.

In some implementations, the controller can flip two bits in the data unit 600 at one time, check whether the data unit after flipping the two bits can pass ECC verification, flip another two bits in the data at another time, check whether the data unit after flipping the two bits can pass ECC verification, . . . , until all possible combinations of two bits in the data unit are flipped and checked.

In some other implementations, with reference to FIG. 7, the controller can flip a first bit in the data unit 600, determine whether the data unit that has the first bit flipped has a single error bit, and if the data unit that has the first bit flipped has a single error bit, flip the single error bit, so that the data unit having the two bits flipped can pass ECC verification.

Specifically, FIG. 7 illustrates an example process 700 of performing brutal-force decoding on a data unit having two error bits.

At 702, the controller starts a loop by setting the loop count i=0 and setting a quantity of decoding solutions M=0.

At 704, the controller determines whether the loop count i is smaller than the number of bits in the data unit (N). If yes, the process 700 proceeds to 706. If no, the process 700 proceeds to 716.

At 706, the controller flips the ith bit in the data unit.

At 708, the controller determines whether the data unit having the ith bit flipped now has a single error bit. In some implementations, the controller can determine whether the data unit has a single error bit by using a function based on Hamming codes.

For example, the data unit with 64 data bits and 8 parity bits forms a 72-bit codeword. The 8 parity bits can be placed at specific positions in the codeword, corresponding to powers of 2: positions 1, 2, 4, 8, 16, 32, 64, etc. The parity bits can check specific subsets of the bits in the codeword. For example, each subset is divided such that the parity bit ensures the number of “1” in the positions it checks is even (in the case of even parity). To determine if there is a single error bit in the data unit, parity checks can be performed for each of the 8 parity bits. The result of each parity check can form a syndrome vector, which indicates whether each parity bit is correct. If a parity bit is correct, the number of “1” in the positions it checks will be even, and the corresponding bit in the syndrome vector will be 0. If the parity bit is incorrect, the number of “1” will be odd, and the corresponding bit in the syndrome vector will be 1. After calculating the syndrome vector, if all bits in the syndrome vector are 0, it means no error is present in the data. However, if the syndrome vector has one or more “1”, it indicates that an error exists in the data unit. The syndrome vector, which is a binary number, corresponds to the position of the erroneous bit in the codeword. The position of the error bit can be determined by converting the syndrome vector into a decimal value, which represents the position of the single error bit. Once the single error bit is identified, it can be flipped to the correct bit. As an example, if the syndrome vector is “00000110”, the decimal value of the syndrome vector is 6, meaning the 6^{th} bit of the data unit is the error bit.

At 714, in response to determining that the data unit having the ith bit flipped has a single error bit, the controller can add one to the quantity of decoding solutions (M), and the process 700 proceeds to 712 into the next loop where i=i+1. In response to determining that the data unit having the ith bit flipped has more than one error bit, the process 700 proceeds to 712 into the next loop where i=i+1.

At 716 (and at 522), after the N loops, the controller identifies a total of M decoding solutions that can pass ECC verification. Each decoding solution identifies a first error bit (e.g., the ith bit) and a second error bit (e.g., the single error bit after flipping the ith bit). Ideally, the brutal-force decoding can identify only one decoding solution that can pass ECC verification. However, in some cases, due to the limitations of the code domain, more than one decoding solution may be identified and need further verification, for example, by reading associated information from the non-volatile memory device.

In some implementations, the algorithm to realize the process 700 can be stored in a tightly coupled memory (not shown in FIG. 1) of the controller, separately from the firmware code of the memory system, which can be stored in the DRAM. Compared to flipping all possible combinations of two bits in the data unit, the process 700 can be more efficient and can reduce the amount of read operations needed for verifying each combination.

Referring back to FIG. 5, at 524, the controller starts a loop by setting the loop count j=0 and setting a quantity of verified decoding solutions A=0.

At 526, the controller determines whether the loop count j is smaller than the quantity of decoding solutions (M). If yes, the process 500 proceeds to 528. If no, the process 500 proceeds to 538.

At 528, the controller identifies a physical address (PA) indicated by the data unit decoded under the j^{th} decoding solution, or in other words, having two bits flipped as indicated by the j^{th} decoding solution.

At 530, the controller reads, from the non-volatile memory device, meta data corresponding to the data stored at the PA. The meta data includes the logical address (LA) of the data stored at the PA.

At 532, the controller determines whether the LA included in the meta data is identical a the LA corresponding to the PA in the L2P mapping table. If yes, the process 500 proceeds to 534. If no, the process 500 proceeds to 536 into the next loop, where j=j+1.

At 534, in response to determining that the LA included in the meta data is identical to t LA that corresponds to the PA in the L2P mapping table, the controller identifies the j^{th} decoding solution as a verified decoding solution, and adds one to the quantity of verified decoding solution (A). Then the process 500 proceeds to 536 into the next loop, where j=j+1.

At 538, after verifying all M decoding solutions, the controller determines whether there is only one verified decoding solution by checking whether A=1. If there is only one verified decoding solution, the controller can determine that the data unit 600 having more than one error bit is successfully recovered, and the process 500 proceeds to 542. If there is zero or more than one verified decoding solution, the controller can determine that the data unit is not successfully recovered, and the process 500 proceeds to 544.

At 542, the controller proceeds with the next operation, without sending a response to the host indicating an unrecoverable read error (e.g., a UECC response).

At 544, the controller sends a response to the host indicating an unrecoverable read error (e.g., a UECC response).

In some implementations, in response to determining that the data type of the data unit having error bits is firmware data or firmware variable, the controller may directly send a response to the host indicating unrecoverable read error, without attempting to recover the data unit.

In some implementations, in response to determining that the data type of the data unit having error bits is host data to be written to the non-volatile memory device, or data received from the non-volatile memory device during garbage collection, the controller may recover the data unit using other approaches, e.g., by the ECC circuit 126 configured to process error correction codes with respect to the data read from or written to the non-volatile memory device.

In some implementations, in response to determining that the data type of the data unit having error bits is a cache entry of the L2P mapping table (e.g., mapping a logical address to a physical address in the DRAM), the controller may not attempt to recover the data unit, since the cache entry is temporary and will be replaced with a new entry that maps the logical address to a physical address in the non-volatile memory device.

In some implementations, the controller can recover the data unit having error bits based on journal data of the memory system, or based on physical-to-logical (P2L) mapping table.

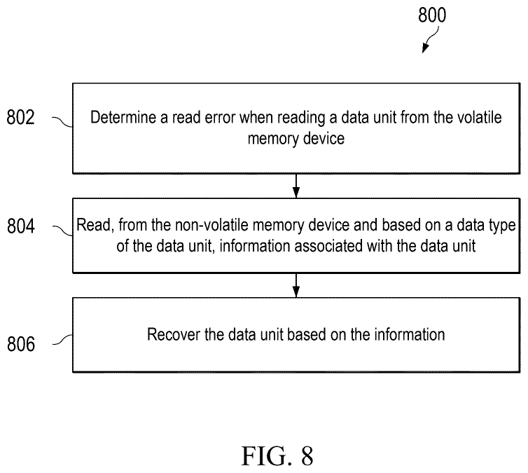

FIG. 8 illustrates a flow chart of an example method 800 of operating a memory system (e.g., memory system 102 of FIG. 1). The memory system can include a volatile memory device (e.g., DRAM 128 of FIG. 1), a non-volatile memory device (e.g., memory device 104 of FIG. 1, or NAND memory device 300 of FIGS. 3-4), and a controller (e.g., controller 106 of FIG. 1) coupled to the volatile memory device and the non-volatile memory device.

Method 800 can be performed by any suitable device or system as described herein, for example, according to the example techniques described with respect to FIGS. 1-7. For example, method 800 can be performed by a memory system, such as the controller 106 of FIGS. 1-2B, the memory device 104 of FIGS. 1-2B, the memory device 300 of FIGS. 3-4.

The operations shown in method 800 may not be exhaustive and that other operations can be performed as well before, after, or in between any of the illustrated operations. Further, some of the operations may be performed simultaneously, or in a different order than shown in FIG. 8. In some implementations, some of the operations may be performed by or one or more components of a device or a system, such as, a controller of a memory system, a peripheral circuit of the memory device.

At 802, the controller determines a read error when reading a data unit (e.g., data unit 600 of FIG. 6) from the volatile memory device. In some implementations, the data unit includes data bits (e.g., data bits 602 of FIG. 6) and parity bits (e.g., parity bits 604 of FIG. 6) generated based on ECC codes (e.g., Hamming codes) corresponding to the data bits. In some implementations, the data unit has more than one error bit.

At 804, the controller reads, based on a data type of the data unit, information associated with the data unit from the non-volatile memory device. For example, if the data unit includes firmware code of the memory system, the controller can read a corresponding portion of an image file of the firmware code from the non-volatile memory device. For example, if the data unit includes mapping information that maps a first logical address to a first physical address, the controller can perform brutal-force decoding on the data unit (e.g., as shown in process 700 of FIG. 7) to identify possible decoding solutions. The controller can further verify each possible decoding solution by reading meta data corresponding to the data stored at the first physical address, and comparing the logical address included in the meta data with the first logical address.

At 806, the controller recovers the data unit based on the information. In some implementations, the controller can recover the data unit by flipping the error bits to the correct bits. In some implementations, the controller can recover the data unit by writing correct data (e.g., data read from the non-volatile memory device) in replacement of the data unit in the volatile memory device, or at a new address in the volatile memory device.

In some implementations, the controller is configured to recover read errors that are random errors (e.g., transient errors arising from external factors such as electrical noise, radiation, or signal interference). The controller may not be able to recover fixed errors (e.g., persistent errors arising from hardware defects). In case of determining a fixed error, the controller can send a response to the host indicating an unrecoverable read error.

The present disclosure also provides a non-transitory computer-readable storage medium. The non-transitory computer-readable storage medium stores one or more instructions (e.g., firmware code of a memory system) that are executable by a processor of a controller and/or a peripheral circuit of a memory device. When being executed by the processor of the controller and/or the peripheral circuit of the memory device, the instructions in the storage medium can implement the method for managing read errors when reading data from a volatile memory device of a memory system, as shown in FIGS. 1-8.

The non-transitory computer-readable storage medium can be an internal storage unit of the device described in any of the foregoing embodiments. For example, the non-transitory computer-readable storage medium can be a hard disk or an internal memory of the device. The non-transitory computer-readable storage medium can also be an external storage device of the device, such as a plug-in hard disk, a smart media card (SMC), a secure digital (SD) card, a flash card, etc. Further, the non-transitory computer-readable storage medium can also include an internal storage unit and an external storage device. In some implementations, the firmware code of the memory system can be stored in a storage medium (e.g., a DRAM coupled to the controller) of the controller, or in a memory array (e.g., a NAND memory array) of the memory device.

While this specification has many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. A memory system, comprising:
a non-volatile memory device;
a volatile memory device; and
a controller coupled to the non-volatile memory device and the volatile memory device, wherein the controller is configured to perform operations comprising:
in response to determining a read error when reading a data unit from the volatile memory device:
reading, from the non-volatile memory device and based on a data type of the data unit, information associated with the data unit; and
recovering the data unit based on the information.

2. The memory system of claim 1, wherein the data unit comprises more than one error bit.

3. The memory system of claim 1, wherein the operations comprise:
in response to determining that the data unit comprises firmware code of the memory system:
identifying an address in an image file of the firmware code that corresponds to the data unit, wherein the image file is stored in the non-volatile memory device;
reading, based on the address, a portion of the image file at the address from the non-volatile memory device; and
recovering the data unit based on the portion of the image file.

4. The memory system of claim 1, wherein the operations comprise:
in response to determining that the data unit comprises mapping information that maps a first logical address to a first physical address in the non-volatile memory device:
reading meta data corresponding to data stored at the first physical address; and
recovering the data unit based on the meta data.

5. The memory system of claim 4, wherein recovering the data unit comprises:
flipping two bits in the data unit; and
determining whether the data unit that has the two bits flipped passes error correction code (ECC) verification.

6. The memory system of claim 5, wherein flipping two bits in the data unit comprises:
flipping a first bit in the data unit;
determining whether the data unit that has the first bit flipped comprises a single error bit; and
in response to determining that the data unit that has the first bit flipped comprises a single error bit, flipping the single error bit.

7. The memory system of claim 6, wherein the controller is configured to determine whether a data unit comprises a single error bit by using a function based on Hamming codes.

8. The memory system of claim 5, wherein flipping two bits in the data unit comprises:
flipping all possible combinations of two bits in the data unit.

9. The memory system of claim 5, wherein recovering the data unit based on the meta data comprises:
in response to determining that the data unit that has the two bits flipped passes ECC verification, determining whether the data unit is successfully recovered by determining whether the first logical address is identical to a second logical address comprised in the meta data.

10. The memory system of claim 1, the operations further comprise:
in response to determining that the data unit is successfully recovered, proceeding with a next operation; and
in response to determining that the data unit is not successfully recovered, sending a response indicating an unrecoverable read error.

11. The memory system of claim 1, wherein the data unit comprises data bits and parity bits, wherein the parity bits are generated based on Hamming codes.

12. The memory system of claim 1, wherein the non-volatile memory device comprises a NAND memory device, and wherein the volatile memory device comprises a DRAM memory device.

13. A method of operating a memory system, comprising:
in response to determining a read error when reading a data unit from a volatile memory device of the memory system:
reading, from a non-volatile memory device of the memory system and based on a data type of the data unit, information associated with the data unit; and
recovering the data unit based on the information.

14. The method of claim 13, wherein the data unit comprises more than one error bit.

15. The method of claim 13, comprising:
in response to determining that the data unit comprises firmware code of the memory system:
identifying an address in an image file of the firmware code that corresponds to the data unit, wherein the image file is stored in the non-volatile memory device;
reading, based on the address, a portion of the image file at the address from the non-volatile memory device; and
recovering the data unit based on the portion of the image file.

16. The method of claim 13, comprising:
in response to determining that the data unit comprises mapping information that maps a first logical address to a first physical address in the non-volatile memory device:
reading meta data corresponding to data stored at the first physical address; and
recovering the data unit based on the meta data.

17. The method of claim 16, wherein recovering the data unit comprises:
flipping two bits in the data unit; and
determining whether the data unit that has the two bits flipped passes error correction code (ECC) verification.

18. The method of claim 17, wherein flipping two bits in the data unit comprises:
flipping a first bit in the data unit;
determining whether the data unit that has the first bit flipped comprises a single error bit; and
in response to determining that the data unit that has the first bit flipped comprises a single error bit, flipping the single error bit.

19. The method of claim 18, comprising:
determining whether a data unit comprises a single error bit by using a function based on Hamming codes.

20. A controller, comprising one or more processors configured to perform operations comprising:
in response to determining a read error when reading a data unit from a volatile memory device coupled to the controller:
reading, from a non-volatile memory device coupled to the controller and based on a data type of the data unit, information associated with the data unit; and
recovering the data unit based on the information.
